(19) United States
(12) Patent Application Publication
(10) Pub. No.: US 2026/0015040 A1
(43) Pub. Date: Jan. 15, 2026

(54) FRONT FRAME STRUCTURE FOR AN ELECTRIC VEHICLE WITH LONGITUDINAL MEMBERS AND ASSOCIATED SUPPORT ELEMENT FOR MOUNTING AN ELECTRIC MOTOR AND ELECTRIC VEHICLE WITH SUCH A FRAME STRUCTURE

(71) Applicant: AUDI AG, Ingolstadt (DE)

(72) Inventors: Sebastian ALBL, Weinböhla (DE); Thomas ARTNER, Neuburg an der Donau (DE); Marek BUJAK, Wellheim (DE); Richard SCHROEDER, lngolstadt (DE); Thomas SCHWARZ, Wettstetten (DE); Tobias URBAN, Besigheim (DE); Stefan WELZ, lngolstadt (DE)

(73) Assignee: AUDI AG, Ingolstadt (DE)

(21) Appl. No.: 19/084,890

(22) Filed: Mar. 20, 2025

(30) Foreign Application Priority Data
Jul. 12, 2024 (DE) 102024119845.1

(51) Int. Cl. B62D 21/03; B60K 1/00; B62D 27/02; B62D 27/06

(52) U.S. Cl. CPC B62D 21/03; B60K 1/00; B62D 27/023; B62D 27/065

(57) ABSTRACT

A front frame structure for a chassis of an electric vehicle includes at least two longitudinal members; a cross member connecting the two longitudinal members in the vehicle width direction; at least two support elements, which are assigned to a respective longitudinal member and are connected to the cross member and/or to the respective longitudinal member. A distance is formed between an inner side of the respective longitudinal member and the respective support element, such that a respective mounting section of an electric motor can be inserted between the support element and the respective longitudinal member and can be or is fastened to the support element and the longitudinal member by a screw connection, wherein an axis of rotation of the screw connection runs essentially in the vehicle width direction.

### FIELD

The invention relates to a front frame structure for a chassis of an electric vehicle with at least two longitudinal members; a cross member connecting the two longitudinal members in the vehicle width direction; at least two support elements which are assigned to a respective longitudinal member and are connected to the cross member and/or to the respective longitudinal member. Furthermore, the invention relates to an electric vehicle with such a front frame structure.

### BACKGROUND

Such a front frame structure is known, for example, from DE 10 2019 201 145 A1, wherein an integrated mount for an electric motor is provided on each of the longitudinal members of the frame structure. In addition, reference is made to DE 10 2011 102 322 A1.

In the well-known front frame structure, the motor mounts are firmly integrated into the usually very stable and rigid longitudinal members. Accordingly, the production of the longitudinal members with motor mounts and of the electric motors must meet very high requirements in terms of low assembly tolerances.

### SUMMARY

The object of the invention is to provide a front frame structure which allows for larger tolerances, particularly during assembly, but which tolerances no longer have any effect in the fully assembled state.

This object is achieved by a front frame structure and an electric vehicle having the features according to the respective independent claims. Advantageous embodiments with expedient developments are specified in the dependent claims.

A front frame structure for a chassis of an electric vehicle is thus proposed, which comprises at least two longitudinal members; a cross member connecting the two longitudinal members in the vehicle width direction; and at least two support elements which are assigned to a respective longitudinal member and are connected to the cross member and/or to the respective longitudinal member. It is provided that a distance is formed between an inner side of the respective longitudinal member and the respective support element, such that a respective mounting section of an electric motor can be inserted between the support element and the respective longitudinal member and can be or is fastened to the support element and the longitudinal member by means of a screw connection, wherein an axis of rotation of the screw connection runs essentially in the vehicle width direction.

In other words, the mounting section is not integrated into the longitudinal member, but is provided on the electric motor. During assembly, the mounting supports of the electric motor are inserted between the respective support element and the respective longitudinal member and tightened using the screw connection. The distance can be selected so that the mounting section can be inserted with high reliability between the support element and the longitudinal member without hitting them or possibly damaging them.

In the front frame structure, the support element can be designed such that, in an assembled state of the electric motor with a tightened screw connection, it is moved towards the inside of the longitudinal member such that the distance to the inside of the respective longitudinal member is smaller than in a state before the assembly of the electric motor. This enables a smooth and dimensionally tolerant introduction of the mounting section, wherein a safe and stable mounting of the electric motor is ensured when assembled.

In the front frame structure, the support element can be welded to the cross member. In other words, the mounting sections of the electric motor or the electric motor are not only mounted on the longitudinal members, but also on the cross member by means of the support element. This ensures that the loads are optimally distributed across the longitudinal and cross members.

In the front frame structure, a threaded section, in particular a weld nut, can be arranged on the support element, which threaded section can be brought into engagement with or is in engagement with a screw passing through the longitudinal member. This makes it possible to easily insert a screw from a lateral position through the longitudinal member and the mounting section of the electric motor during assembly and then screw it into the threaded section already present on the support section and tighten it.

In the front frame structure, the support element can be designed to be elastically or plastically deformable in such a way that it can be moved towards the inside of the longitudinal member when the screw connection is tightened. In other words, the support element can be pulled or deformed in the direction of the respective longitudinal member. The support element can be movable in the region of the screw connection by, for example, 0.5 to 2.0 mm relative to the respective longitudinal member. In other words, the distance between the support element and the longitudinal member can be about 0.5 to 2.0 mm larger before assembly than after tightening the screw connection.

Also proposed is an electric vehicle with a front frame structure described above and with an electric motor which is fastened to the front frame structure, wherein at least two mounting sections are formed on the electric motor with a respective mounting core which is received between the inner side of the respective longitudinal member and the respective support element.

In the electric vehicle, the mounting sections can be connected to a housing of the electric motor in a material-locking and/or force-fitting manner or the mounting sections can be formed integrally with the housing. In other words, the mounting sections can be fastened to the electric motor or its housing as separate components, or they can be formed integrally during the casting of the housing.

In the electric vehicle, the mounting sections can be screwed to the respective longitudinal member, wherein the screw connection is arranged in the longitudinal direction of the electric vehicle behind a wheel brake device and in front of a bulkhead cross member.

Also proposed is an electric motor for a front frame structure as described above, wherein the electric motor has at least three mounting sections, of which two mounting sections are arranged at the top rear relative to an installation position of the electric motor in an electric vehicle with a mounting orientation in the width direction of the electric vehicle, wherein it is provided that the two rear mounting sections are connected to a housing of the electric motor in a material-locking and/or force-fitting manner or that the rear mounting sections are formed integrally with the housing.

### BRIEF DESCRIPTION OF THE FIGURES

Further advantages and details of the invention will become apparent from the following description of embodiments with reference to the figures. In particular:

FIG. 1 is a simplified and schematic perspective view of a front frame structure;

FIG. 2 is a simplified and schematic perspective view of a mounting of an electric motor by means of a support element of the front frame structure;

FIG. 3 is a simplified and schematic sectional view according to the section line III-III of FIG. 2 after the assembly of the electric motor;

FIG. 4 is a simplified and schematic sectional view according to the section line III-III of FIG. 2 at or during the assembly of the electric motor.

### DETAILED DESCRIPTION

FIG. 1 shows a simplified and schematic perspective partial view of a front frame structure 10 for a chassis of an electric vehicle 12 illustrated as a dash-dotted rectangle.

The front frame structure 10 comprises at least two longitudinal members 14. The two longitudinal members 14 are connected, in particular in the region in front of a vehicle cabin (not shown), to cross members 16 running in the vehicle width direction Y. The cross member 16 can also be part of a partition 16t between the motor compartment and the vehicle cabin.

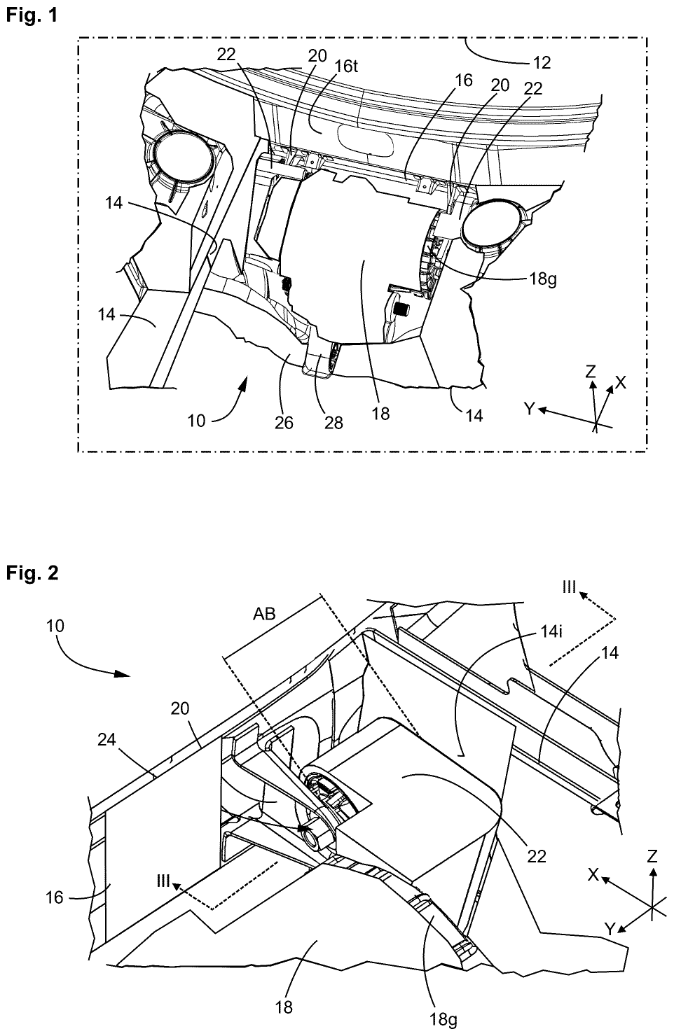

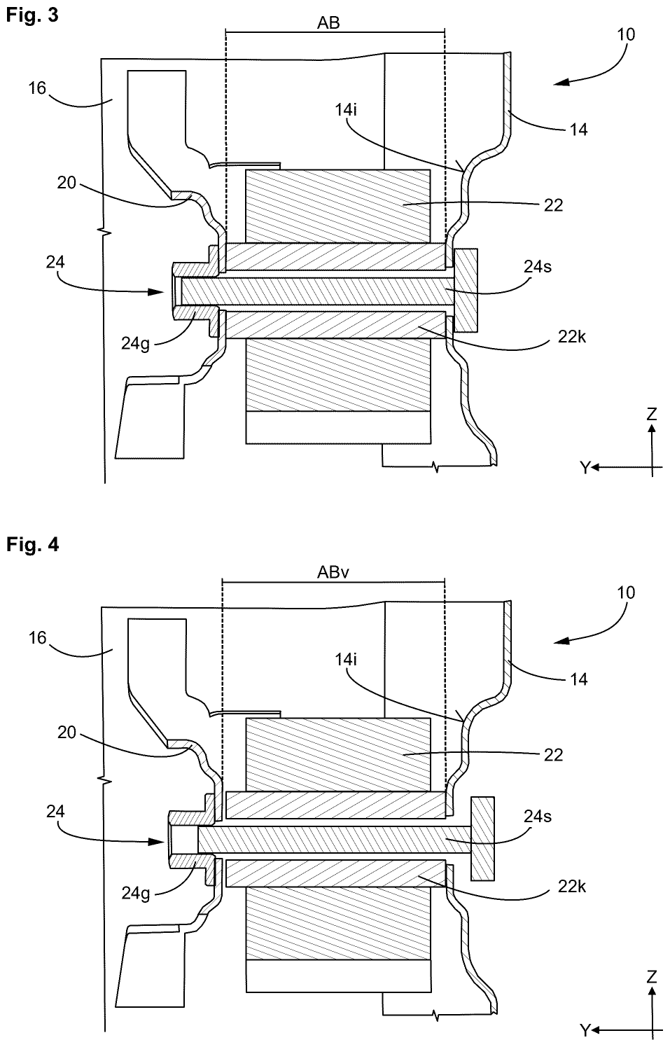

An electric motor 18 is arranged between the longitudinal members 14 and is also mounted or fastened thereto, which is described in more detail below with reference to FIGS. 2 and 3.

The front frame structure 10 comprises at least two support elements 20. From FIG. 2 it can be seen that the support element 20 is assigned to its (respective) longitudinal member 14 and is connected to the cross member 16.

In the example shown in FIG. 2, the support element 20 is welded to the cross member 16. The support element 20 projects forward from the cross member 16 essentially in the longitudinal direction X.

From FIG. 2 it is also apparent that a distance AB is formed between an inner side 14i of the longitudinal member 14 and the support element 20, so that a mounting section 22 of the electric motor 18 can be inserted between the support element 20 and the longitudinal member 14 and can be or is fastened to the support element 20 and the longitudinal member 14 by means of a screw connection 24. In this case, an axis of rotation of the screw connection 24 extends essentially in the vehicle width direction Y.

FIG. 3 shows a simplified and schematic sectional view of the support element 20, of the mounting section 22 and of the longitudinal member 14 of FIG. 2 approximately according to section line III-III. In FIG. 3, a mounted state of the electric motor 18 on the longitudinal member 14 and the support element 20 is illustrated.

FIG. 4 shows a sectional view essentially corresponding to FIG. 3, wherein a state during or at mounting of the electric motor 18 before tightening the screw connection 24 is illustrated.

From the combination of FIGS. 3 and 4, it is apparent that the support element 20 is designed such that in the assembled state (FIG. 3) of the electric motor 18 with the screw connection 24 tightened, it is moved towards the inner side 14i of the longitudinal member 14 such that the distance AB to the inner side 14i of the longitudinal member 14 is smaller than in a state before or during the assembly of the electric motor 18.

In FIG. 3 and also in FIG. 2 the smaller distance AB is shown, while in FIG. 4 the slightly larger distance ABv is illustrated before assembly or before tightening the screw connection 24.

The support element 20 can therefore be designed to be elastically or plastically deformable, so that it is moved towards the inner side 14i of the longitudinal member 14 when the screw connection 24 is tightened.

The support element 20 can be movable in the region of the screw connection 24 by, for example, 0.5 to 2.0 mm relative to the respective longitudinal member 14. In other words, the distance ABv between the support element 20 and the longitudinal member 14 can be about 0.5 to 2.0 mm larger before assembly than after tightening the screw connection 24.

From FIGS. 2 to 4 it is also apparent that a threaded section 24g, in particular a weld nut, is arranged on the support element 20, which threaded section can be brought into engagement with or is in engagement with a screw 24s passing through the longitudinal member.

From the sectional views of FIGS. 3 and 4 it is also apparent that the mounting section 22 has a mounting core 22k, shown here only in simplified form, which is received between the inner side 14i of the longitudinal member 14 and the support element 20.

As already explained above with reference to FIG. 1, in the electric vehicle 12 the electric motor 18 is fastened to the front frame structure 10, wherein at least two mounting sections 22 are formed on the electric motor 18 each with a respective mounting core 22k (FIGS. 3 and 4) which is received between the inner side 14i of the respective longitudinal member 14 and the respective support element 20.

The mounting sections 22 can be connected to a housing 18g (FIGS. 1 and 2) of the electric motor in a material-locking and/or force-fitting manner. Alternatively, the mounting sections 22 can be formed integrally with the housing 18g.

In the electric vehicle 12, the mounting sections 22 can be screwed to the respective longitudinal member 14, wherein the screw connection is arranged in the longitudinal direction X of the electric vehicle 12 behind a wheel brake device, not shown, and in front of a bulkhead cross member 16.

The electric motor 18 is further supported or mounted in a front, lower region of the frame structure 10 on a further cross member 26, which can also be seen from FIG. 1. For this purpose, the electric motor 18 can be fastened to the cross member 26 by means of a further mounting section 28.

The electric motor 18 for the front frame structure 10 as described above can have at least three mounting sections 22, 28, of which two mounting sections 22 are arranged at the top rear relative to an installation position of the electric motor 18 in an electric vehicle 12 with a mounting orientation in the width direction Y of the electric vehicle 12, wherein it is provided that the two rear mounting sections 22 are connected to the housing 18g of the electric motor 18 in a material-locking and/or force-fitting manner or that the rear mounting sections 22 are formed integrally with the housing 18g.

1. A front frame structure for a chassis of an electric vehicle comprising: at least two longitudinal members;
a cross member connecting the two longitudinal members in the vehicle width direction;
at least two support elements which are assigned to a respective longitudinal member and are connected to the cross member and/or to the respective longitudinal member,
wherein a distance is formed between an inner side of the respective longitudinal member and the respective support element, such that a respective mounting section of an electric motor can be inserted between the support element and the respective longitudinal member and can be or is fastened to the support element and the longitudinal member by a screw connection, wherein an axis of rotation of the screw connection runs essentially in the vehicle width direction.

2. The front frame structure according to claim 1, wherein the support element is designed such that in an assembled state of the electric motor with a tightened screw connection it is moved towards the inner side of the longitudinal member such that the distance to the inner side of the respective longitudinal member is smaller than in a state before the assembly of the electric motor.

3. The front frame structure according to claim 1, wherein the support element is welded to the cross member.

4. The front frame structure according to claim 1, wherein a threaded section, in particular a weld nut, is arranged on the support element, which threaded section can be brought into engagement with or is in engagement with a screw passing through the longitudinal member.

5. The front frame structure according to claim 1, wherein the support element is designed to be elastically or plastically deformable, such that it is movable towards the inner side of the longitudinal member when the screw connection is tightened.

6. An electric vehicle with a front frame structure according to claim 1 and with an electric motor which is fastened to the front frame structure, wherein at least two mounting sections are formed on the electric motor with a respective mounting core which is received between the inner side of the respective longitudinal member and the respective support element.

7. The electric vehicle according to claim 6, wherein the mounting sections are connected to a housing of the electric motor in a material-locking and/or force-fitting manner or in that the mounting sections are formed integrally with the housing.

8. The electric vehicle according to claim 6, wherein the mounting sections are screwed to the respective longitudinal member, wherein the screw connection is arranged in the longitudinal direction of the electric vehicle behind a wheel brake device and in front of a front wall cross member.

9. An electric motor for a front frame structure according to claim 1, wherein the electric motor has at least three mounting sections, of which two mounting sections are arranged at the top rear relative to an installation position of the electric motor in an electric vehicle with a mounting orientation in the width direction of the electric vehicle, characterized in that the two rear mounting sections are connected to a housing of the electric motor in a material-locking and/or force-fitting manner or in that the rear mounting sections are formed integrally with the housing.

10. The front frame structure according to claim 2, wherein the support element is welded to the cross member.

11. The front frame structure according to claim 2, wherein a threaded section, in particular a weld nut, is arranged on the support element, which threaded section can be brought into engagement with or is in engagement with a screw passing through the longitudinal member.

12. The front frame structure according to claim 3, wherein a threaded section, in particular a weld nut, is arranged on the support element, which threaded section can be brought into engagement with or is in engagement with a screw passing through the longitudinal member.

13. The front frame structure according to claim 2, wherein the support element is designed to be elastically or plastically deformable, such that it is movable towards the inner side of the longitudinal member when the screw connection is tightened.

14. The front frame structure according to claim 3, wherein the support element is designed to be elastically or plastically deformable, such that it is movable towards the inner side of the longitudinal member when the screw connection is tightened.

15. The front frame structure according to claim 4, wherein the support element is designed to be elastically or plastically deformable, such that it is movable towards the inner side of the longitudinal member when the screw connection is tightened.

16. The electric vehicle according to claim 7, wherein the mounting sections are screwed to the respective longitudinal member, wherein the screw connection is arranged in the longitudinal direction of the electric vehicle behind a wheel brake device and in front of a front wall cross member.
